(19) United States
(12) Patent Application Publication
(10) Pub. No.: US 2026/0227653 A1
(43) Pub. Date: Aug. 6, 2026

(54) WAVEGUIDE DEVICE

(71) Applicant: NGK INSULATORS, LTD., Nagoya-shi (JP)

(72) Inventors: Kentaro TANI, Nagoya-shi (JP); Jungo KONDO, Miyoshi-shi (JP); Hironori KURIMOTO, Kasugai-shi (JP); Tomoyoshi TAI, Inazawa-shi (JP); Shoichiro YAMAGUCHI, Ichinomiya-shi (JP)

(21) Appl. No.: 19/634,204

(22) Filed: Mar. 31, 2026

Related U.S. Application Data
(63) Continuation of application No. PCT/JP2023/038073, filed on Oct. 20, 2023.

(51) Int. Cl. G02F 1/035

(52) U.S. Cl. CPC G02F 1/035

(57) ABSTRACT

A waveguide device includes a waveguide, a low refractive index layer, and a support substrate. The waveguide is formed of an optical functional material. The waveguide is buried in the low refractive index layer. The low refractive index layer includes a first cladding part. The first cladding part is positioned on a side opposite to the support substrate across the waveguide. The waveguide includes a first end portion and a second end portion. A width of the first end portion is equal to or smaller than a width of the second end portion, and is from 0.60 to 1.00 with respect to the width of the second end portion. The width of the first end portion is from 0.80 to 1.30 with respect to a thickness dimension of the waveguide. A thickness of the first cladding part is 0.30 or more with respect to the height of the waveguide.

### CROSS-REFERENCE TO RELATED APPLICATIONS

This application is a continuation under 35 U.S.C. 120 of International Application PCT/JP2023/038073 having the International Filing Date of Oct. 20, 2023. The identified application is fully incorporated herein by reference.

### BACKGROUND OF THE INVENTION

### 1. Field of the Invention

The present disclosure relates to a waveguide device.

### 2. Description of the Related Art

As one of an electro-optical device and a non-linear optical device, development of a waveguide device is in progress. The waveguide device is expected to be applied and deployed in a wide range of fields such as an optical waveguide, next-generation high-speed communication, a quantum computer, quantum communication, sensor, laser processing, and solar power generation. For example, a waveguide device including a ridge waveguide has been proposed (see Non Patent Literature 1).

### CITATION LIST

### Non Patent Literature

[NPL 1] Yifan Qi and Yang Li, Integrated lithium niobate photonics, Nanophotonics, 2020, 9(6), pp. 1287-1320

### SUMMARY OF THE INVENTION

In the waveguide device as described in Non Patent Literature 1, in some cases, another waveguide member such as an optical fiber is connected to an exit side of the ridge waveguide depending on the application. However, when the ridge waveguide and the another waveguide member are connected to each other, there is a fear that a light wave exiting from the ridge waveguide does not sufficiently enter the another waveguide member, resulting in increase in optical coupling loss.

A primary object of the present disclosure is to provide a waveguide device that can be connected to another waveguide member with an excellent coupling efficiency.

[1] According to an embodiment of the present disclosure, a waveguide device includes a waveguide, a low refractive index layer, and a support substrate. The waveguide is formed of an optical functional material.

The waveguide is buried in the low refractive index layer. The low refractive index layer is formed of a low refractive index material having a refractive index smaller than a refractive index of the optical functional material. The support substrate supports the low refractive index layer. The low refractive index layer includes a first cladding part. The first cladding part is positioned on a side opposite to the support substrate across the waveguide in a thickness direction of the low refractive index layer. The waveguide includes a first end portion and a second end portion in the thickness direction of the low refractive index layer. The second end portion is positioned on a side opposite to the first end portion. In a width direction orthogonal to the thickness direction of the low refractive index layer and a direction in which the waveguide extends, a dimension of the first end portion is equal to or smaller than a dimension of the second end portion. In the width direction of the waveguide, the dimension of the first end portion is from 0.60 to 1.00 with respect to the dimension of the second end portion. The dimension of the first end portion in the width direction of the waveguide is from 0.80 to 1.30 with respect to a dimension of the waveguide in the thickness direction of the low refractive index layer. In the thickness direction of the low refractive index layer, a dimension of the first cladding part is 0.30 or more with respect to the dimension of the waveguide.

[2] In the waveguide device according to the above-mentioned item [1], the low refractive index layer may further include a second cladding part. The second cladding part is positioned on a side opposite to the first cladding part across the waveguide in the thickness direction of the low refractive index layer. In the thickness direction of the low refractive index layer, a dimension of the second cladding part may be from 0.5 to 5.0 with respect to the dimension of the waveguide.

[3] In the waveguide device according to the above-mentioned item [1] or [2], the first end portion of the waveguide may be in contact with the first cladding part. In this case, the second end portion of the waveguide is in contact with the second cladding part.

[4] In the waveguide device according to the above-mentioned item [1] or [2], the first end portion of the waveguide may be in contact with the second cladding part. In this case, the second end portion of the waveguide is in contact with the first cladding part.

According to the embodiment of the present disclosure, it is possible to achieve the waveguide device that can be connected to another waveguide member with an excellent coupling efficiency.

### BRIEF DESCRIPTION OF THE DRAWINGS

FIG. 1 is a schematic perspective view of a waveguide device according to one embodiment of the present disclosure.

FIG. 2 is a middle cross-sectional view of the waveguide device of FIG. 1.

FIG. 3 is an explanatory schematic cross-sectional view for illustrating a method of manufacturing the waveguide device of FIG. 2, and shows a step of joining an optical waveguide substrate and a support substrate to each other through intermediation of a second low refractive index layer.

FIG. 4 is a schematic cross-sectional view subsequent to FIG. 3, for illustrating a step of etching the optical waveguide substrate to form a waveguide.

FIG. 5 is a schematic cross-sectional view for illustrating a case in which a recessed portion is formed in the second low refractive index layer in the etching of FIG. 4.

FIG. 6 is a schematic cross-sectional view of a waveguide device according to another embodiment of the present disclosure.

FIG. 7 is a schematic cross-sectional view of a waveguide device according to still another embodiment of the present disclosure.

FIG. 8 is an explanatory schematic cross-sectional view for illustrating a method of manufacturing the waveguide device of FIG. 7, and shows a step of forming a third low refractive index layer on the optical waveguide substrate having an unevenness formed thereon.

FIG. 9 shows a step subsequent to FIG. 8 of joining the third low refractive index layer formed on the optical waveguide substrate and the second low refractive index layer formed on the support substrate to each other.

FIG. 10 shows a step subsequent to FIG. 9 of polishing the optical waveguide substrate.

FIG. 11 is a sectional SEM image of the waveguide device obtained in Example 1.

### DESCRIPTION OF THE EMBODIMENTS

Embodiments of the present disclosure are described below. However, the present disclosure is not limited to these embodiments. In addition, in the drawings, the width, thickness, shape, and the like of each portion may be schematically illustrated as compared to those in the embodiments in order to provide clearer description, but the drawings are merely examples and do not limit the interpretation of the present disclosure.

### A. Outline of Waveguide Device

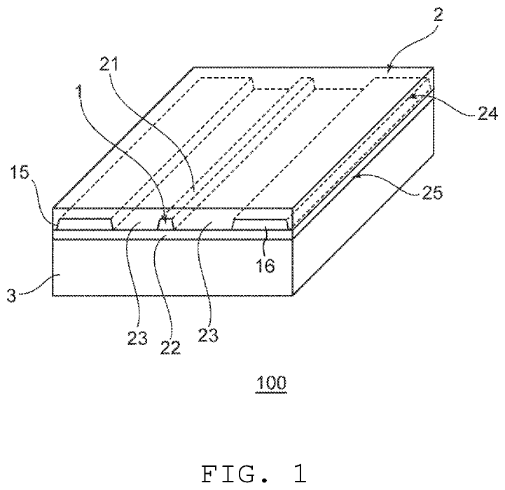

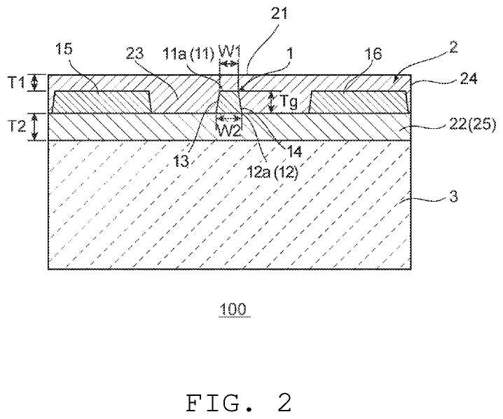

FIG. 1 is a schematic perspective view of a waveguide device according to one embodiment of the present disclosure, and FIG. 2 is a middle cross-sectional view of the waveguide device of FIG. 1.

A waveguide device 100 can typically propagate light waves of from ultraviolet light to an infrared ray. Ultraviolet light is typically a light wave having a wavelength of about 200 nm, and an infrared ray is typically a light wave having a wavelength of about 5 μm.

The wavelength of the light wave that can be propagated by the waveguide device 100 is, for example, from 200 nm to 10 μm, further, for example, from 300 nm to 5 μm, still further, for example, from 350 nm to 3 μm, and yet further, for example, from 400 nm to 2 μm.

As illustrated in FIG. 1 and FIG. 2, the waveguide device 100 includes a waveguide 1, a low refractive index layer 2, and a support substrate 3. The waveguide 1 is formed of an optical functional material. As the optical functional material, typically, an electro-optical crystal material and a non-linear optical material are given. The waveguide 1 is buried in the low refractive index layer 2. This allows the low refractive index layer 2 to cover the periphery of the waveguide 1. The waveguide 1 typically extends in a direction intersecting with a thickness direction of the low refractive index layer 2. In the illustrated example, the waveguide 1 linearly extends to be orthogonal to the thickness direction of the low refractive index layer 2. The low refractive index layer 2 is formed of a low refractive index material having a refractive index that is lower than that of the optical functional material. The support substrate 3 supports the low refractive index layer 2.

The low refractive index layer 2 includes a first cladding part 21. The first cladding part 21 is positioned on a side opposite to the support substrate 3 across the waveguide 1 in the thickness direction of the low: refractive index layer 2. Typically, the first cladding part 21 overlaps the entire waveguide 1 as viewed from above (from the side opposite to the support substrate 3 across the waveguide 1 in the thickness direction of the low refractive index layer 2). The first cladding part 21 extends at least in the same direction as that of the waveguide 1. Further, the entire part of the low refractive index layer 2 positioned above the waveguide 1 (side opposite to the support substrate 3) may be formed as the first cladding part 21. In the illustrated example, the first cladding part 21 extends in a first surface direction that is parallel with a direction in which the waveguide 1 extends and in a second surface direction that is orthogonal to the first surface direction, and is provided across the entire low refractive index layer 2.

As illustrated in FIG. 2, the waveguide 1 includes a first end portion 11 and a second end portion 12 in the thickness direction of the low refractive index layer 2. The second end portion 12 is positioned on a side opposite to the first end portion 11. A dimension of the first end portion 11 in a width direction that is orthogonal to the thickness direction of the low refractive index layer 2 and the direction in which the waveguide 1 extends (hereinafter referred to as “width W1 of the first end portion 11”) is equal to or smaller than a dimension of the second end portion 12 in the width direction of the waveguide 1 (hereinafter referred to as “width W2 of the second end portion 12”). The width W1 of the first end portion 11 is from 0.60 to 1.00 with respect to the width W2 of the second end portion 12. In the illustrated example, the width direction of the waveguide 1 and the second surface direction of the low refractive index layer 2 are substantially parallel with each other. The width W1 of the first end portion 11 is from 0.80 to 1.30 with respect to a dimension of the waveguide 1 in the thickness direction of the low refractive index layer 2 (hereinafter referred to as “height Tg of the waveguide 1”). A dimension of the first cladding part 21 in the thickness direction of the low refractive index layer 2 (hereinafter referred to as “thickness T1 of the first cladding part 21”) is 0.30 or more with respect to the height Tg of the waveguide 1.

The inventors of the present disclosure have found that a mode shape of a light wave exiting from the optical waveguide (hereinafter referred to as “exiting wave”) affects the coupling loss obtained when another waveguide member (typically, an optical fiber) is connected to the waveguide device. In view of the above, as a result of intensively investigating the mode shape of the exiting wave, the inventors of the present disclosure have found that, when the mode shape of the exiting wave is made closer to a true circle, a coupling efficiency between the waveguide device and the another waveguide member can be improved.

Further, in the related art, bringing a ratio X/Y of a size X of the mode shape in the width direction of the waveguide to a size Y of the mode shape in the height direction of the waveguide close to 1 has not been widely attempted. The reason therefor is because it has been difficult to form the low refractive index layer to surround the waveguide. For this reason, it has also been difficult to make the mode shape closer to a true circle. For this reason, the size X of the mode shape in the width direction of the waveguide has been increased so far, and, for example, when the waveguide device is caused to function as an optical modulator, it has been difficult to narrow a gap distance of modulation electrodes arranged on both sides of the optical waveguide. Thus, this has become one cause of preventing a half-wave voltage that becomes a drive voltage of the optical modulator from being reduced. With the structure of the present disclosure, the mode shape can be made closer to the true circle, and thus the half-wave voltage can also be reduced by narrowing a gap between the electrodes.

Moreover, the present disclosure has a structure in which an outer periphery of the optical waveguide is surrounded by the low refractive index layer. With this structure, the effective refractive index of the optical waveguide can be reduced. The reduction of the effective refractive index allows the influence of dispersion of the refractive index of the optical waveguide substrate to be reduced. In general, an electro-optical crystal material and a non-linear optical material have a large wavelength dispersion of the refractive index. In contrast, a material for forming the low refractive index layer has small wavelength dispersion of the refractive index. When the wavelength dispersion of the effective refractive index of the optical waveguide is small, at the time of application as an optical modulator, there is an effect of increase in bandwidth of a modulation frequency. Further, in the case of the non-linear optical material, a phase-matched wavelength can be achieved in a wide wavelength range, and hence there is a feature that a wavelength conversion device that can operate in a high wavelength band can be achieved.

In one embodiment of the present disclosure, the waveguide 1 is buried in the low refractive index layer 2 so that, in the waveguide 1, the width W1 of the first end portion 11 with respect to the width W2 of the second end portion 12 and the width W1 of the first end portion 11 with respect to the height Tg of the waveguide 1 fall within the above-mentioned ranges, and the thickness T1 of the first cladding part 21 with respect to the height Tg of the waveguide 1 falls within the above-mentioned range, and hence the mode shape of the exiting wave from the waveguide 1 can be made closer to the true circle. The mode shape can be measured by, for example, near-field measurement equipment for the exiting wave, and, from this mode shape, a distance in the thickness direction and a distance in the surface direction with which the optical power takes the maximum value of 1/e² can be defined as the dimension Y and the dimension X, respectively.

The ratio (X/Y) of the dimension X of the mode shape of the exiting wave in a direction (surface direction) orthogonal to the thickness direction of the low refractive index layer 2 to the dimension Y of the mode shape of the exiting wave in the thickness direction of the low refractive index layer 2 is, for example, from 0.9 to 1.1, preferably from 0.95 to 1.0.

As a result, a waveguide device that can be connected to another waveguide member with an excellent coupling efficiency can be achieved.

The width W1 of the first end portion 11 with respect to the width W2 of the second end portion 12 (“width W1 of first end portion 11”/“width W2 of second end portion 12”) is preferably from 0.64 to 1.00, more preferably from 0.70 to 1.00, further more preferably from 0.75 to 1.00, particularly preferably from 0.80 to 1.00. When the width W1 of the first end portion 11 with respect to the width W2 of the second end portion 12 falls within such a range, the mode shape of the exiting wave can be stably made closer to a true circle.

The width W1 of the first end portion 11 is, for example, from 0.3 μm to 4.5 μm, preferably from 0.5 μm to 3.0 μm.

The width W2 of the second end portion 12 is, for example, from 0.3 μm to 4.5 μm, preferably from 0.5 μm to 3.0 μm.

The width W1 of the first end portion 11 with respect to the height Tg of the waveguide 1 (“width W1 of first end portion 11”/“height Tg of waveguide 1”) is preferably from 0.80 to 1.25, more preferably 0.85 to 1.25, further more preferably from 0.90 to 1.22. When the width W1 of the first end portion 11 with respect to the height Tg of the waveguide 1 falls within such a range, the mode shape of the exiting wave can be more stably made closer to a true circle.

The height Tg of the waveguide 1 is, for example, 4.5 μm or less, preferably 4.0 μm or less, more preferably 3.0 μm or less, further more preferably 1.5 μm or less. Meanwhile, the lower limit of the height Tg of the waveguide 1 is typically 0.5 μm. When the height Tg of the waveguide 1 is 4.0 μm or less, the waveguide 1 can have a sufficiently reduced size. Further, when the height Tg of the waveguide 1 is 3.0 μm or less, damage caused by a process of forming the waveguide 1 can be stably reduced. Moreover, when the height Tg of the waveguide 1 is 1.5 μm or less, the waveguide device 100 can be stably downsized.

The thickness T1 of the first cladding part 21 with respect to the height Tg of the waveguide 1 (“thickness T1 of first cladding part 21”/“height Tg of waveguide 1”) is 0.30 or more, but in practice, there may be a limitation of the thickness of the first cladding part 21 to be formed, and hence the thickness T1 is preferably from 0.40 to 2.0, more preferably 0.45 to 1.5, further more preferably from 0.50 to 1.2. When the thickness T1 of the first cladding part 21 with respect to the height Tg of the waveguide 1 falls within such a range, the mode shape of the exiting wave can be still more stably made closer to a true circle.

The thickness T1 of the first cladding part 21 is, for example, 0.3 μm or more, further, for example, 0.5 μm or more, and still further, for example, 1 μm or more. Meanwhile, the upper limit of the thickness T1 of the first cladding part 21 is typically 5 μm.

In one embodiment, the low refractive index layer 2 further includes a second cladding part 22. The second cladding part 22 is positioned on a side opposite to the first cladding part 21 across the waveguide 1 in the thickness direction of the low refractive index layer 2. Typically, the second cladding part 22 overlaps the entire waveguide 1 as viewed from below (from the support substrate 3 side with respect to the waveguide 1 in the thickness direction of the low refractive index layer 2). The second cladding part 22 extends in the same direction as that of the waveguide 1. Further, the entire part of the low refractive index layer 2 positioned below the waveguide 1 (support substrate 3 side) may be formed as the second cladding part 22. In the illustrated example, the second cladding part 22 extends in the first surface direction that is parallel with the direction in which the waveguide 1 extends and the second surface direction that is orthogonal to the first surface direction, and is provided across the entire low refractive index layer 2.

A dimension of the second cladding part 22 in the thickness direction of the low refractive index layer 2 (hereinafter referred to as “thickness T2 of the second cladding part 22”) is, for example, from 0.5 to 5.0, preferably from 1.0 to 3.0 with respect to the height Tg of the waveguide 1. When the thickness T2 of the second cladding part 22 with respect to the height Tg of the waveguide 1 falls within such a range, the light wave propagating through the waveguide can be prevented from being shifted to the support substrate side, and an optical waveguide having a small loss can be achieved.

The thickness T2 of the second cladding part 22 is, for example, 0.3 μm or more, preferably 0.5 μm or more, more preferably 1 μm or more. Meanwhile, the upper limit of the thickness T2 of the second cladding part 22 is typically 5 μm.

In one embodiment, the low refractive index layer 2 further includes a third cladding part 23. The third cladding part 23 is typically positioned between the first cladding part 21 and the second cladding part 22 in the thickness direction of the low refractive index layer 2. The third cladding part 23 is adjacent to the waveguide 1 in the surface direction of the low refractive index layer 2.

The low refractive index layer 2 may have a single-layer structure or a multilayer structure. In the illustrated example, the low refractive index layer 2 has a multilayer structure including a first low refractive index layer 24 and a second low refractive index layer 25.

In one embodiment, the first low refractive index layer 24 is positioned on a side opposite to the support substrate 3 across the second low refractive index layer 25 in the thickness direction of the low refractive index layer 2. In the illustrated example, the first low refractive index layer 24 is in contact with the second low refractive index layer 25. The first low refractive index layer 24 integrally includes the first cladding part 21 and the third cladding part 23.

In one embodiment, the second low refractive index layer 25 is positioned between the first low refractive index layer 24 and the support substrate 3 in the thickness direction of the low refractive index layer 2. In the illustrated example, the second low refractive index layer 25 is in contact with each of the waveguide 1 and the support substrate 3. The second low refractive index layer 25 joins the waveguide 1 to the support substrate 3. The second low refractive index layer 25 includes the second cladding part 22.

As illustrated in FIG. 1, the waveguide 1 typically forms a ridge waveguide, and extends in a predetermined direction. One end surface in the direction in which the waveguide 1 extends is formed as an input facet which allows the above-mentioned light wave to enter the waveguide 1. Another end surface in the direction in which the waveguide 1 extends is formed as an output facet from which the above-mentioned light wave exits. The length of the waveguide 1 is suitably and appropriately adjusted depending on the application.

The waveguide 1 has any appropriate shape in a cross section taken along the direction orthogonal to the direction in which the waveguide 1 extends. Examples of the cross-sectional shape of the waveguide 1 include quadrilaterals such as a square, a rectangle, a trapezoid, and a parallelogram. In the illustrated example, the cross-sectional shape of the waveguide 1 is a trapezoidal shape that tapers as separating away from the support substrate 3.

As illustrated in FIG. 2, in one embodiment, the first end portion 11 of the waveguide 1 is in contact with the first cladding part 21, and the second end portion 12 of the waveguide 1 is in contact with the second cladding part 22. In this embodiment, the first end portion 11 of the waveguide 1 is an end portion on a side opposite to the support substrate 3 in the height direction of the waveguide 1. Further, the second end portion 12 of the waveguide 1 is an end portion on the support substrate 3 side in the height direction of the waveguide 1.

The waveguide 1 typically includes a first surface 11a, a second surface 12a, a third surface 13, and a fourth surface 14.

The first surface 11a is one end surface in the height direction of the waveguide 1. The first end portion 11 includes the first surface 11a. In the illustrated example, the first surface 11a is in contact with the first cladding part 21.

The second surface 12a is an end surface on a side opposite to the first surface 11a in the height direction of the waveguide 1. The second end portion 12 includes the second surface 12a. In the illustrated example, the second surface 12a is in contact with the second cladding part 22.

Each of the third surface 13 and the fourth surface 14 is an end surface in the width direction of the waveguide 1. The third surface 13 couples one end portion of the first surface 11a in the width direction and one end portion of the second surface 12a in the width direction. The fourth surface 14 couples another end portion of the first surface 11a in the width direction and another end portion of the second surface 12a in the width direction. In the illustrated example, each of the third surface 13 and the fourth surface 14 is in contact with the third cladding part 23.

The above-mentioned height Tg of the waveguide 1 is typically a distance between a first imaginary line described below and a second imaginary line described below in the thickness direction of the low refractive index layer 2. The first imaginary line passes through a part (point) of the first end portion 11 (first surface 11a) which is most separated away from the support substrate 3 in the thickness direction of the low refractive index layer 2, and is parallel with the width direction of the waveguide 1. The second imaginary line passes through a part (point) of the second end portion 12 (second surface 12a) which is closest to the support substrate 3 in the thickness direction of the low refractive index layer 2, and is parallel with the width direction of the waveguide 1.

Further, the above-mentioned thickness T1 of the first cladding part 21 is typically a distance between the above-mentioned first imaginary line and a third imaginary line described below in the thickness direction of the low refractive index layer 2. The third imaginary line passes through a part (point) of the low refractive index layer 2 (first low refractive index layer 24) which is most separated away from the support substrate 3 in the surface on a side opposite to the support substrate 3, and is parallel with the width direction of the waveguide 1.

Further, the above-mentioned thickness T2 of the second cladding part 22 is typically a distance between the above-mentioned second imaginary line and the support substrate 3.

Further, the above-mentioned width W1 of the first end portion 11 (first surface 11a) is typically a dimension (length of a line segment) between a first intersection described below and a second intersection described below in the above-mentioned first imaginary line. The first intersection is an intersection between a first tangent line passing through a center of the third surface 13 in the height direction of the waveguide 1 and the above-mentioned first imaginary line. The second intersection is an intersection between a second tangent line passing through a center of the fourth surface 14 in the height direction of the waveguide 1 and the above-mentioned first imaginary line.

Further, the above-mentioned width W2 of the second end portion 12 (second surface 12a) is typically a dimension between a third intersection described below and a fourth intersection described below in the above-mentioned second imaginary line. The third intersection is an intersection between the above-mentioned first tangent line and the above-mentioned second imaginary line. The fourth intersection is an intersection between the above-mentioned second tangent line and the above-mentioned second imaginary line.

Further, an angle (tapered angle) of a corner formed between the above-mentioned second imaginary line and the above-mentioned first tangent line or second tangent line is, for example, from 75° to 90°, preferably from 80° to 90°, more preferably from 85° to 90°.

The thickness of the third cladding part 23 in contact with the third surface 13 is, in a first normal direction orthogonal to the first tangent line, for example, 0.3 μm or more, further, for example, 0.5 μm or more, and still further, for example, 1.0 μm or more. Further, the thickness of the third cladding part 23 in contact with the fourth surface 14 is, in a second normal direction orthogonal to the second tangent line, for example, 0.3 μm or more, further, for example, 0.5 μm or more, and still further, for example, 1.0 μm or more.

In the low refractive index layer 2, in addition to the waveguide 1, any appropriate member may be buried. In the illustrated example, a first functional portion 15 and a second functional portion 16 are buried in the low refractive index layer 2. In other words, the waveguide device 100 includes the first functional portion 15 and the second functional portion 16.

The first functional portion 15 is typically formed of an optical functional material (specifically, an electro-optical crystal material or a non-linear optical material). The first functional portion 15 has any appropriate function. Examples of the first functional portion 15 include a waveguide, an electrode forming surface, a dissimilar material joining surface, and an exposure prevention surface. The first functional portion 15 is positioned away from the waveguide 1 in the width direction of the waveguide 1. A distance between the waveguide 1 and the first functional portion 15 in the width direction of the waveguide 1 is, for example, 4 μm or more, preferably 6 μm or more. The upper limit of the distance between the waveguide 1 and the first functional portion 15 in the width direction of the waveguide 1 is typically 20 μm. The second functional portion 16 can be described in the same manner as with the first functional portion 15. Accordingly, the description of the second functional portion 16 is omitted.

### B. Details of Waveguide Device

In the following, details of members of the waveguide device are described.

### B-1. Support Substrate

The support substrate 3 can provide an excellent mechanical strength to the waveguide device 100. The support substrate 3 is bonded to the low refractive index layer 2 to reinforce the low refractive index layer 2. In other words, the support substrate 3 is a reinforcing substrate for reinforcing the low refractive index layer 2.

The support substrate 3 is formed of any appropriate inorganic material. The inorganic material may be a single crystal or a polycrystal. Examples of the inorganic material include silicon (Si), silicon carbide (SiC), sapphire, indium phosphide (InP), gallium arsenide (GaAs), gallium nitride (GaN), quartz, and glass. Of those, Si and InP are preferred.

The support substrate 3 has any appropriate shape. Examples of the shape of the support substrate 3 as viewed from the thickness direction include a triangle, a quadrilateral, a pentagon, a substantial polygon having six or more sides, a substantially circular shape, or a substantially elliptical shape, and of those, a substantially circular shape is preferred.

The size of the support substrate 3 can be appropriately set in accordance with the purpose. When the support substrate 3 has a substantial disc shape, the diameter of the support substrate 3 is, for example, from 50 mm to 300 mm, preferably from 100 mm to 200 mm.

The thickness of the support substrate 3 is, for example, from 150 μm to 750 μm, preferably from 250 μm to 600 μm.

### B-2. Low Refractive Index Layer (First Low Refractive Index Layer and Second Low Refractive Index Layer)

The low refractive index layer 2 is typically provided directly on the support substrate 3. As described above, the refractive index of the low refractive index layer 2 is smaller than the refractive index of the optical functional material which forms the waveguide 1 (typically, the electro-optical crystal material or the non-linear optical material). Accordingly, the low refractive index layer 2 typically functions as a cladding layer.

The refractive index of the low refractive index layer 2 is, for example, 2.0 or less, preferably 1.8 or less. Meanwhile, the lower limit of the refractive index of the low refractive index layer 2 is typically 1.4.

A difference in refractive index between the waveguide 1 and the low refractive index layer 2 is, for example, 0.2 or more, preferably 0.3 or more. Meanwhile, the upper limit of the difference in refractive index between the waveguide 1 and the low refractive index layer 2 is typically 1.2.

The low refractive index layer 2 is formed of any appropriate metal oxide. Examples of the metal oxide include SiO₂, Al₂O₃, Ta₂O₅, Nb₂O₅, HfO₂, and TiO₂. The metal oxides can be used alone or in combination. Of the metal oxides, SiO₂ and Al₂O₃ are preferred. In addition, a metal fluoride can also be used as the material of the low refractive index layer 2. Examples of the metal fluoride include MgF₂ and CaF₂.

The thickness of the low refractive index layer 2 is, for example, from 300 nm to 5,000 nm, preferably from 1,000 nm to 3,000 nm.

In the illustrated example, the low refractive index layer 2 includes the above-mentioned first low refractive index layer 24 and the above-mentioned second low refractive index layer 25. The material for forming the first low refractive index layer 24 and the material for forming the second low refractive index layer 25 may be the same as each other, or may be different from each other.

The thickness of the first low refractive index layer 24 is suitably and appropriately adjusted so that the thickness T1 of the first cladding part 21 falls within the above-mentioned range. The thickness of the second low refractive index layer 25 is suitably and appropriately adjusted so that the thickness T2 of the second cladding part 22 falls within the above-mentioned range.

### B-3. Waveguide

The waveguide 1 is buried in the low refractive index layer 2. In the illustrated example, the waveguide 1 is directly provided on the surface of the second low refractive index layer 25 on a side opposite to the support substrate 3, and is covered with the first low refractive index layer 24.

The waveguide 1 is typically formed of an electro-optical crystal material or a non-linear optical material.

Examples of the electro-optic crystal material for forming the waveguide 1 include a lithium niobate (LiNbO₃, LN) single crystal, a lithium tantalate (LiTaO₃, LT) single crystal, a potassium titanyl phosphate (KTiOPO₄, KTP) single crystal, a potassium tantalate (KTaO₃, LN) single crystal, potassium tantalate niobate (KTa₁₋ₓNbₓO₃, KTN), quartz, lead zirconate titanate (PZT), lead lanthanum zirconate titanate (PLZT), and barium titanate (BaTiO₃, BTO).

In addition, examples of the non-linear optical material for forming the waveguide 1 include silicon carbide (Sic), silicon nitride (SiN), glass, MgF₂, and CaF₂.

Those materials for forming the waveguide 1 can be used alone or in combination. Of the materials for forming the waveguide 1, the electro-optical crystal material is preferred, and the LN single crystal is more preferred.

A dopant may be added to the optical functional material. Examples of the dopant include Mg, Zn, and Zr. A content ratio of the dopant in the optical functional material is, for example, from 0.1% mol to 10% mol, and is, for example, from 1% mol to 6% mol.

### C. Method of Manufacturing Waveguide Device

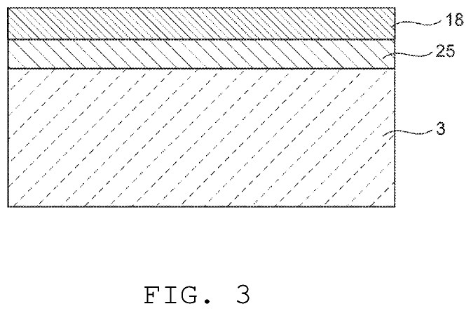

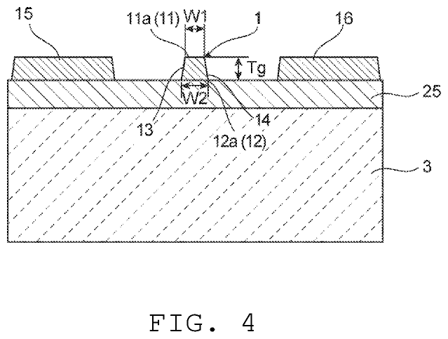

Next, with reference to FIG. 3 and FIG. 4, a method of manufacturing the waveguide device 100 is described.

In one embodiment, an optical waveguide substrate (optical functional material substrate) 18 formed of the above-mentioned optical functional material and the above-mentioned support substrate 3 are prepared.

The c-axis (direction of polarization) of the optical waveguide substrate 18 may be substantially parallel with the thickness direction (normal direction) of the optical waveguide substrate 18, or may be substantially parallel with the surface direction (tangential direction) orthogonal to the thickness direction of the optical waveguide substrate 18. Further, the c-axis may be between the normal direction and the tangential direction, which is called an off-cut.

The range of the thickness of the optical waveguide substrate 18 is, for example, similar to the above-mentioned range of the height Tg of the waveguide 1.

Next, the above-mentioned second low refractive index layer 25 is formed on the surface of the optical waveguide substrate 18.

As a film forming method, any appropriate film forming method can be adopted. Examples of the film forming method include sputtering, chemical vapor deposition (CVD), vapor deposition, a sol-gel method, and aerosol deposition (AD method). Of those, sputtering and CVD are preferred. It is generally said that, in particular, CVD has a good coverage for coating in the case of having an uneven shape, and coating can be performed without a gap in accordance with the waveguide shape.

Further, as required, on the surface of the support substrate 3, a film formed of the above-mentioned material of the low refractive index layer may be formed. When silicon or a SiC wafer is used for the support substrate 3, as a method of forming a SiO₂ layer on the substrate, a thermal oxide film can be adopted.

Moreover, a joining layer (not shown) may be formed on the second low refractive index layer 25 by the above-mentioned film forming method. The material of the joining layer is suitably and appropriately selected depending on the material of the support substrate 3. Examples of the material of the joining layer include amorphous silicon, Ta₂O₅, Al₂O₃, TiO₂, and Nb₂O₅. When the support substrate 3 is formed of silicon, for example, amorphous silicon is adopted as the material of the joining layer.

Next, the optical waveguide substrate 18 and the support substrate 3 are directly joined to each other.

For example, direct joining can be achieved by the following procedure. In a high vacuum chamber (for example, about 1×10⁻⁶ Pa), a joining surface of each of constituent elements (layers or substrates) to be joined is irradiated with a neutralization beam. The joining surface is planarized in advance by polishing as required. As the polishing method, for example, chemical mechanical polishing processing (CMP processing) is given. In one embodiment, when the surface is activated by the neutralization beam, an inert gas is introduced into the chamber, and a high voltage is applied from a DC power supply to an electrode arranged in the chamber. With such a configuration, an electron moves owing to an electric field generated between the electrode (positive electrode) and the chamber (negative electrode), and beams of atoms and ions are generated by the inert gas. Among the beams reaching the grid, an ion beam is neutralized by the grid, and hence a beam of neutral atoms is emitted from a high-speed atom beam source. The atomic species forming the beam are preferably inert gas elements (for example, argon (Ar) and nitrogen (N)). A voltage at the time of activation by beam irradiation is, for example, from 0.5 kV to 2.0 kV, and a current is, for example, from 50 mA to 200 mA. An irradiation time of the neutralization beam is, for example, from 10 seconds to 300 seconds, preferably from 30 seconds to 120 seconds. In this manner, each joining surface, more specifically, a beam applied surface is activated.

Next, in a vacuum atmosphere at a normal temperature (23° C.), the activated joining surfaces are brought into contact with each other. A load at the time of contact can be, for example, from 100 N to 20,000 N.

In this manner, the optical waveguide substrate 18 and the support substrate 3 are joined to each other through intermediation of the second low refractive index layer 25, and thus a laminate having a structure of the optical waveguide substrate 18, the second low refractive index layer 25, and the support substrate 3 can be obtained. The method of direct joining is not limited thereto, and a surface activation method using a fast atom beam (FAB) or an ion gun, an atomic diffusion method, a plasma bonding method, or the like can also be applied.

The laminate is subjected to heating treatment as required. This allows a joining strength between the optical waveguide substrate and the support substrate to be improved. A heating temperature is, for example, from 60° C. to 140° C., preferably from 80° C. to 120° C. A heating time is, for example, from 10 minutes to 5 hours, preferably from 30 minutes to 3 hours.

After that, as required, the optical waveguide substrate 18 may be polished so that the optical waveguide substrate 18 has a uniform thickness. Examples of the method of polishing the optical waveguide substrate 18 include grinding (grinder), lapping, and chemical mechanical polishing processing (CMP processing). The polishing method may be carried out alone or may be carried out in combination of two or more types. Grinding (grinder) and CMP processing are preferably carried out in the stated order.

Next, as illustrated in FIG. 4, the waveguide 1 is formed from the optical waveguide substrate 18. In the illustrated example, from the optical waveguide substrate 18, the waveguide 1, the first functional portion 15, and the second functional portion 16 are collectively formed.

As a method of forming the waveguide 1, any appropriate method can be adopted. In one embodiment, the optical waveguide substrate 18 is etched so that the waveguide 1 is formed.

More specifically, on the optical waveguide substrate 18, an etching mask (not shown) having a predetermined pattern shape is formed. The etching mask typically covers a part of the optical waveguide substrate 18 corresponding to the waveguide 1. Further, as required, the etching mask covers parts of the optical waveguide substrate 18 corresponding to the first functional portion 15 and the second functional portion 16.

After that, the optical waveguide substrate 18 is etched via the etching mask by any appropriate etching method. As the etching method, for example, reactive ion etching (RIE) is given.

In this manner, the waveguide 1 is formed on the second low refractive index layer 25.

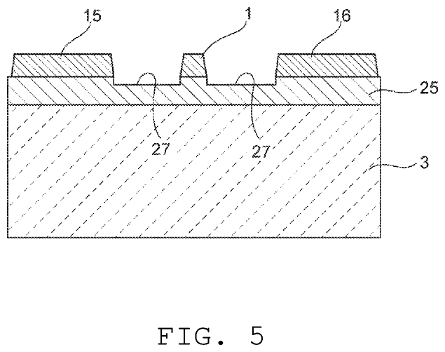

At this time, as illustrated in FIG. 5, a part of the second low refractive index layer 25 may be etched. In this case, a recessed portion 27 is formed in the second low refractive index layer 25.

Next, as illustrated in FIG. 2, the first low refractive index layer 24 is formed on the second low refractive index layer 25 so that the waveguide 1 is covered. As a method of forming the first low refractive index layer 24, for example, the above-mentioned film forming method is given. The surface of the first low refractive index layer 24 is planarized by polishing as required. As the polishing method, for example, chemical mechanical polishing processing (CMP processing) is given.

In the manner described above, the waveguide device 100 is manufactured.

### D. Second Embodiment

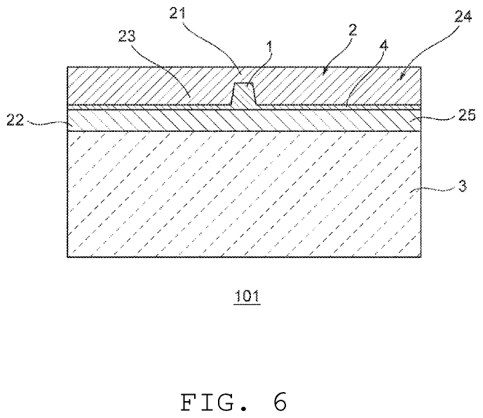

Next, with reference to FIG. 6, another embodiment (second embodiment) of the waveguide device is described.

In the waveguide device 100 illustrated in FIG. 2, the second end portion 12 of the waveguide 1 is in contact with the second cladding part 22 (second low refractive index layer 25). In contrast, a waveguide device 101 illustrated in FIG. 6 further includes a thin film portion 4, and the second end portion 12 of the waveguide 1 is connected to the thin film portion 4. Accordingly, the second end portion 12 of the waveguide 1 is not in contact with the second cladding part 22 (second low refractive index layer 25).

The thin film portion 4 is formed of the above-mentioned optical functional material (typically, the electro-optical crystal material or the non-linear optical material). The thin film portion 4 is provided on the surface of the second low refractive index layer 25 on a side opposite to the support substrate 3. That is, the thin film portion 4 is in contact with the second cladding part 22. The first low refractive index layer 24 is positioned on a side opposite to the second low refractive index layer 25 across the thin film portion 4. The thin film portion 4 may be provided only on a part of the surface of the second low refractive index layer 25, or may be provided on the entire surface of the second low refractive index layer 25. In the illustrated example, the thin film portion 4 is provided on the entire surface of the second low refractive index layer 25. The thickness of the thin film portion 4 is, for example, from 0.1% to 20% when the above-mentioned height Tg of the waveguide 1 is regarded as 100%.

The waveguide 1 protrudes from the surface of the thin film portion 4 on a side opposite to the second low refractive index layer 25. In this embodiment, the second end portion 12 of the waveguide 1 is a part of the waveguide 1 connected to the thin film portion 4.

### E. Third Embodiment

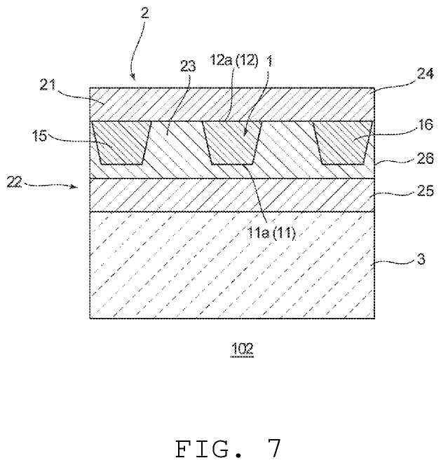

Next, with reference to FIG. 7, still another embodiment (third embodiment) of the waveguide device is described.

In the waveguide device 100 illustrated in FIG. 2 and the waveguide device 101 illustrated in FIG. 6, the cross-sectional shape of the waveguide 1 is a trapezoidal shape that tapers as separating away from the support substrate 3.

In contrast, in a waveguide device 102 illustrated in FIG. 7, a cross-sectional shape of the waveguide 1 is oriented oppositely in the thickness direction of the low refractive index layer 2, and is a trapezoidal shape that widens as separating away from the support substrate 3. In this case, the first end portion 11 of the waveguide 1 is in contact with the second cladding part 22, and the second end portion 12 of the waveguide 1 is in contact with the first cladding part 21. In this embodiment, the first end portion 11 of the waveguide 1 is an end portion on the support substrate 3 side in the height direction of the waveguide 1. Further, the second end portion 12 of the waveguide 1 is an end portion on a side opposite to the support substrate 3 in the height direction of the waveguide 1.

Further, in the waveguide device 102, the low refractive index layer 2 includes the first low refractive index layer 24, the third low refractive index layer 26, and the second low refractive index layer 25 in the stated order. The material for forming the first low refractive index layer 24, the material for forming the second low refractive index layer 25, and the material for forming the third low refractive index layer 26 may be the same as each other, or may be different from each other.

The first low refractive index layer 24 is positioned on a side opposite to the support substrate 3 across the waveguide 1 in the thickness direction of the low refractive index layer 2. In the illustrated example, the first low refractive index layer 24 is in contact with the waveguide 1 and the third low refractive index layer 26. In this embodiment, the first low refractive index layer 24 includes the first cladding part 21.

The second low refractive index layer 25 is positioned between the third low refractive index layer 26 and the support substrate 3 in the thickness direction of the low refractive index layer 2. In the illustrated example, the second low refractive index layer 25 is in contact with each of the third low refractive index layer 26 and the support substrate 3.

The third low refractive index layer 26 is positioned between the first low refractive index layer 24 and the second low refractive index layer 25 in the thickness direction of the low refractive index layer 2.

The second low refractive index layer 25 and a part of the third low refractive index layer 26 form the second cladding part 22, and the remaining part of the third low refractive index layer 26 forms the third cladding part 23. The thickness of the third low refractive index layer 26 is suitably and appropriately adjusted so that the thickness T2 of the second cladding part 22 falls within the above-mentioned range. Thus, in some cases, the thickness T2 may not include the third low refractive index layer 26.

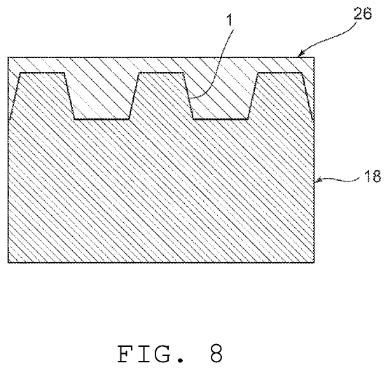

Next, with reference to FIG. 8 to FIG. 10, a method of manufacturing the waveguide device 102 is described.

As illustrated in FIG. 8, in one embodiment, the above-mentioned waveguide substrate 18 is prepared, and unevenness corresponding to the waveguide 1 is formed on the surface of the optical waveguide substrate 18 by any appropriate etching method. As the etching method, typically, reactive ion etching is given.

Next, the third low refractive index layer 26 is formed so as to cover the unevenness by the above-mentioned film forming method. After that, as required, the surface of the third low refractive index layer 26 is suitably and appropriately polished.

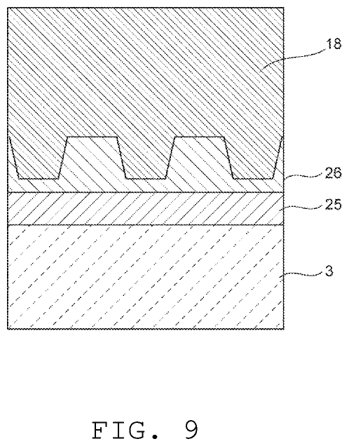

Further, as illustrated in FIG. 9, the above-mentioned support substrate 3 is prepared, and the second low refractive index layer 25 is formed on the surface of the support substrate 3 by the above-mentioned film forming method.

After that, the third low refractive index layer 26 on the optical waveguide substrate 18 and the second low refractive index layer 25 on the support substrate 3 are joined to each other by, for example, the above-mentioned direct joining. Before the direct joining, the surfaces of both substrates may be polished by CMP or the like for flattening.

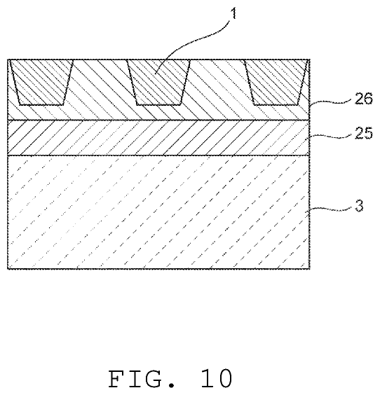

Next, as illustrated in FIG. 10, the optical waveguide substrate 18 is polished from the side opposite to the third low refractive index layer 26 until the third low refractive index layer 26 is exposed. Examples of the method of polishing the optical waveguide substrate 18 include grinding (grinder), lapping, and chemical mechanical polishing processing (CMP processing).

After that, as illustrated in FIG. 7, on the polished surface, the first low refractive index layer 24 is formed by the above-mentioned film forming method.

In the manner described above, the waveguide device 102 is manufactured.

### EXAMPLES

Now, the present disclosure is specifically described by way of Examples. However, the present disclosure is not limited to these Examples. Measurement methods for characteristics are as described below.

### (1) Simulation of Mode Shape of Exiting Wave

In the waveguide devices obtained by Examples and Comparative Examples, the mode shape of the exiting wave was computer-simulated under the following conditions. The dimension X of 1/e² of the mode shape of the exiting wave in the width direction of the waveguide, the dimension Y of 1/e² of the mode shape of the exiting wave in the height direction of the waveguide, and X/Y are shown in Table 1.

### <Simulation Conditions>

Mode analysis by beam propagation method: RSoft manufactured by Synopsys, Inc.
Wavelength: 1.55 μm

### (2) Simulation of Effective Refractive Index of Waveguide

In the waveguide devices obtained by Examples 1 to 3 and 8 and Comparative Example 1, the effective refractive index of the waveguide was computer-simulated. Results of the simulation are shown in Table 1.

### Example 1

A lithium niobate substrate (LN substrate) was prepared as the optical waveguide substrate. The LN substrate was an X-cut substrate. The thickness of the LN substrate was 1.0 μm. In addition, a silicon wafer having a disc shape was prepared as the support substrate. The thickness of the silicon wafer was 500 μm.

Next, on the surface of the LN substrate, a film to be formed of SiO₂ to become the second low refractive index layer was formed by sputtering. Moreover, as the joining layer, an amorphous silicon film was formed. After the film formation, CMP processing was performed for flattening and planarizing. Next, on the surface of the film formed on the LN substrate and the surface of the support substrate, in an ultra-high vacuum chamber, a neutral Ar atomic beam was applied for about 60 seconds. In this manner, the surface irradiated with the beam was activated. After that, the film on the LN substrate and the support substrate were brought into contact with each other. Then, elements present in the vicinity of the joining interface were diffused as being mixed with each other to form an amorphous layer (not shown). As a result, the LN substrate, the second low refractive index layer, and the silicon wafer were joined to each other. The thickness of the second low refractive index layer was 2.0 μm.

As a result, a laminate having the structure of the LN substrate, the SiO₂ layer, and the silicon wafer was obtained.

Next, the LN substrate side of the produced laminate was thinned by polishing. As the polishing method, grinding (grinder) processing was performed, and then CMP was performed so that the thickness within the substrate surface was adjusted to be Tg and uniform.

Next, on the LN substrate, an etching mask having a predetermined pattern shape was formed. The etching mask covered a part of the LN substrate corresponding to the waveguide. After that, a part of the LN substrate exposed from the etching mask was removed by reactive ion etching so that a waveguide extending in a predetermined direction was formed. A cut surface cut in a direction orthogonal to a direction in which the waveguide extended had a substantially trapezoidal shape that tapered as separating away from the silicon wafer. The width W1 of the first surface (top base) of the waveguide, the width W2 of the second surface (bottom base) of the waveguide, the height Tg of the waveguide, W1/W2, and W1/Tg are shown in Table 1.

Next, the first low refractive index layer formed of SiO₂ was formed by CVD so as to cover the waveguide. The first low refractive index layer integrally included the first cladding part positioned on a side opposite to the support substrate across the waveguide, and the third cladding part positioned between the first cladding part and the second low refractive index layer. Further, the second low refractive index layer is positioned on a side opposite to the first cladding part across the waveguide, and functions as the second cladding part. The thickness T1 of the first cladding part, the thickness T2 of the second cladding part, T1/Tg, and T2/Tg are shown in Table 1.

In the manner described above, the waveguide device was manufactured. The waveguide device included the waveguide, the low refractive index layer (first low refractive index layer and second low refractive index layer) in which the waveguide was buried, and the support substrate (silicon).

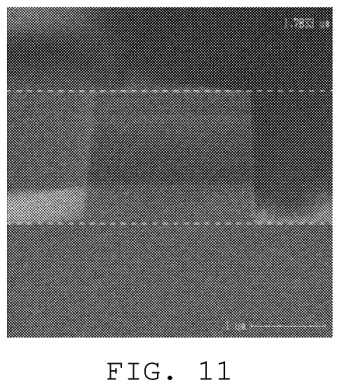

The sectional SEM image of the waveguide device obtained in Example 1 was acquired by the following apparatus and conditions. The sectional SEM image is shown in FIG. 11.
SEM apparatus: S-3400N manufactured by Hitachi High-Tech Corporation
Measurement condition: acceleration voltage of 20 kV
Observation magnification: 10,000 times

Methods other than the above-mentioned method can also be applied as the method of manufacturing the waveguide device of Example 1. In particular, the second low refractive index layer can be formed by forming a thermal oxide film on the silicon wafer. In this case, for the joining of the optical waveguide substrate and the silicon wafer, not only the surface activation method but also plasma bonding can be used. Even in the case of joining through use of the above-mentioned joining layer, the joining layer can be formed on the support substrate side for joining. The material of the joining layer is suitably and appropriately selected as described above.

### Examples 2 and 3

The waveguide device was manufactured similarly to Example 1 except that the thickness of the optical waveguide substrate was changed so that the height Tg of the waveguide was changed as shown in Table 1.

### Examples 4 to 7

The waveguide device was manufactured similarly to Example 1 except that the width of the second surface (bottom base) of the waveguide was changed as shown in Table 1.

### Example 8

The waveguide device was manufactured similarly to Example 1 except that the thickness of the first cladding part was changed to 0.45 μm.

### Comparative Example 1

The waveguide device was manufactured similarly to Example 1 except that the first low refractive index layer was not formed.

### Comparative Example 2

A waveguide device having a structure represented in NTT Technical REVIEW Vol. 18, No. 5, pp. 35-42, May 2020 was manufactured. Specifically, through use of a ZnO-doped Z-cut LN as a core, a direct bonded wafer having a magnesium oxide (MgO)-doped LN as a cladding layer was used, and a ridge structure was formed by dry etching. The shape of the ridge waveguide is shown in Table 1. Next, in order to prevent propagation loss of the waveguide from being induced by an electrode, the ridge of the waveguide portion was covered with a silicon dioxide (SiO₂) buffer layer.

### Comparative Examples 3 and 4

The waveguide device was manufactured similarly to Example 1 except that the thickness of the optical waveguide substrate was changed so that the height Tg of the waveguide was changed as shown in Table 1.

TABLE 1

| | | | Example | Example | Example | Example | Example | Example | Example | Example |
|---|---|---|---|---|---|---|---|---|---|---|
| No. | | | 1 | 2 | 3 | 4 | 5 | 6 | 7 | 8 |
| Waveguide | Width W1 | [μm] | 0.97 | 0.97 | 0.97 | 0.97 | 0.97 | 0.97 | 0.97 | 0.97 |
| | of first | | | | | | | | | |
| | surface | | | | | | | | | |
| | (top base) | | | | | | | | | |
| | Width W2 | [μm] | 1.32 | 1.29 | 1.25 | 0.97 | 1.14 | 1.33 | 1.52 | 1.32 |
| | of second | | | | | | | | | |
| | surface | | | | | | | | | |
| | (bottom | | | | | | | | | |
| | base) | | | | | | | | | |
| | Height Tg | [μm] | 1.00 | 0.90 | 0.80 | 1.00 | 1.00 | 1.00 | 1.00 | 1.00 |
| | W1/W2 | [—] | 0.73 | 0.75 | 0.78 | 1.00 | 0.85 | 0.73 | 0.64 | 0.73 |
| | W1/Tg | [—] | 0.97 | 1.08 | 1.21 | 0.97 | 0.97 | 0.97 | 0.97 | 0.97 |
| Low | Thickness | [μm] | 0.50 | 0.50 | 0.50 | 0.50 | 0.50 | 0.50 | 0.50 | 0.45 |
| refractive | T1 of first | | | | | | | | | |
| index layer | cladding | | | | | | | | | |
| | part | | | | | | | | | |
| | Thickness | [μm] | 2.00 | 2.00 | 2.00 | 2.00 | 2.00 | 2.00 | 2.00 | 2.00 |
| | T2 of | | | | | | | | | |
| | second | | | | | | | | | |
| | cladding | | | | | | | | | |
| | part | | | | | | | | | |
| T1/Tg | | [—] | 0.50 | 0.56 | 0.63 | 0.50 | 0.50 | 0.50 | 0.50 | 0.45 |
| T2/Tg | | [—] | 2.00 | 2.22 | 2.50 | 2.00 | 2.00 | 2.00 | 2.00 | 2.00 |
| Mode shape | X | [—] | 1.003 | 1.012 | 1.009 | 1.003 | 1.003 | 1.050 | 1.100 | 1.004 |
| of exiting | Y | [—] | 1.007 | 1.011 | 1.012 | 1.003 | 1.007 | 1.007 | 1.007 | 0.984 |
| wave | X/Y | [—] | 0.996 | 1.001 | 0.997 | 1.000 | 0.996 | 1.043 | 1.092 | 1.020 |
| Waveguide | Effective | [—] | 1.981 | 1.982 | 1.984 | — | — | — | — | 1.977 |
| | refractive | | | | | | | | | |
| | index | | | | | | | | | |

| | | | Comparative | Comparative | Comparative | Comparative |
|---|---|---|---|---|---|---|
| No. | | | Example 1 | Example 2 | Example 3 | Example 4 |
| Waveguide | Width W1 | [μm] | 0.97 | 7.53 | 0.97 | 0.97 |
| | of first | | | | | |
| | surface | | | | | |
| | (top base) | | | | | |
| | Width W2 | [μm] | 1.32 | 7.00 | 1.22 | 1.18 |
| | of second | | | | | |
| | surface | | | | | |
| | (bottom | | | | | |
| | base) | | | | | |
| | Height Tg | [μm] | 1.00 | 10.00 | 0.70 | 0.60 |
| | W1/W2 | [—] | 0.73 | 0.75 | 0.80 | 0.82 |
| | W1/Tg | [—] | 0.97 | 1.07 | 1.39 | 1.62 |
| Low | Thickness | [μm] | 0 | 1.00 | 0.50 | 0.50 |
| refractive | T1 of first | | | | | |
| index layer | cladding | | | | | |
| | part | | | | | |
| | Thickness | [μm] | 2.00 | >100 | 2.00 | 2.00 |
| | T2 of | | | | | |
| | second | | | | | |
| | cladding | | | | | |
| | part | | | | | |
| T1/Tg | | [—] | 0 | 0.14 | 0.71 | 0.83 |
| T2/Tg | | [—] | 2.00 | >14 | 2.86 | 3.33 |
| Mode shape | X | [—] | 0.928 | 6.85 | 1.080 | 1.100 |
| of exiting | Y | [—] | 0.984 | 6.14 | 0.820 | 0.750 |
| wave | X/Y | [—] | 0.943 | 1.116 | 1.317 | 1.467 |
| Waveguide | Effective | [—] | 1.963 | 2.146 | — | — |
| | refractive | | | | | |
| | index | | | | | |

### [Evaluation]

As is clear from Table 1, it is found that, in the waveguide, when the width W1 of the first surface with respect to the width W2 of the second surface (W1/W2) is from 0.60 to 1.00, the width W1 of the first surface with respect to the height Tg of the waveguide (W1/Tg) is from 0.80 to 1.30, and the thickness T1 of the first cladding part with respect to the height Tg of the waveguide (T1/Tg) is 0.30 or more, X/Y in the mode shape of the exiting wave can be made closer to 1. That is, the mode shape of the exiting wave can be made closer to a true circle. As a result, the waveguide device and another waveguide member (typically, an optical fiber) can be connected to each other with an excellent coupling efficiency.

Further, the result of calculating the effective refractive index of the waveguide is smaller than 2. The refractive index of LN is 2.15 in a wavelength band of 1.55 μm, and is 2 or more in a normal optical waveguide. In the structure of the present disclosure, the refractive index of LN is less than 2, and this indicates that the refractive index of LN is significantly affected by the low refractive index layer. The SiO₂ layer is a material having a wavelength dispersion smaller than that of LN, and hence it is considered that the wavelength dispersion of the effective refractive index of the optical waveguide is also decreased.

The waveguide device according to the embodiments of the present disclosure can be typically used in a wide range of fields such as a waveguide, next-generation high-speed communication, a quantum computer, quantum communication, a sensor, laser processing, solar power generation, and an optical modulator, and, in particular, can be suitably used as a waveguide for from UV light to an infrared ray.

What is claimed is:

1. A waveguide device, comprising:
a waveguide formed of an optical functional material;
a low refractive index layer in which the waveguide is buried, the low refractive index layer being formed of a low refractive index material having a refractive index smaller than a refractive index of the optical functional material; and
a support substrate configured to support the low refractive index layer,
wherein the low refractive index layer includes a first cladding part positioned on a side opposite to the support substrate across the waveguide in a thickness direction of the low refractive index layer,
wherein the waveguide includes a first end portion and a second end portion positioned on a side opposite to the first end portion, in the thickness direction of the low refractive index layer,
wherein, in a width direction orthogonal to the thickness direction of the low refractive index layer and a direction in which the waveguide extends, a dimension of the first end portion is equal to or smaller than a dimension of the second end portion, and is from 0.60 to 1.00 with respect to the dimension of the second end portion,
wherein the dimension of the first end portion in the width direction of the waveguide is from 0.80 to 1.30 with respect to a dimension of the waveguide in the thickness direction of the low refractive index layer, and
wherein, in the thickness direction of the low refractive index layer, a dimension of the first cladding part is 0.30 or more with respect to the dimension of the waveguide.

2. The waveguide device according to claim 1,
wherein the low refractive index layer further includes a second cladding part positioned on a side opposite to the first cladding part across the waveguide in the thickness direction of the low refractive index layer, and
wherein, in the thickness direction of the low refractive index layer, a dimension of the second cladding part is from 0.5 to 5 with respect to the dimension of the waveguide.

3. The waveguide device according to claim 2,
wherein the first end portion of the waveguide is in contact with the first cladding part, and
wherein the second end portion of the waveguide is in contact with the second cladding part.

4. The waveguide device according to claim 2,
wherein the first end portion of the waveguide is in contact with the second cladding part, and
wherein the second end portion of the waveguide is in contact with the first cladding part.
